(19) United States
(12) Patent Application Publication
(10) Pub. No.: US 2007/0159933 A1
(43) Pub. Date: Jul. 12, 2007

(54) Optical pickup

(75) Inventors: Yoshikazu Sugimoto, Osaka (JP); Tetsuya Yoshida, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/650,444

(22) Filed: Jan. 8, 2007

(30) Foreign Application Priority Data
Jan. 10, 2006 (JP) 2006-002118

(51) Int. Cl. G11B 7/085; G11B 21/08

(52) U.S. Cl. 369/30.03

(57) ABSTRACT

An optical pickup that improves recording and reproducing performances on a disc without increasing the cost includes first and second magnets. The first magnet is placed on protrusions provided to a first wall portion of a base of an actuator portion. Both end portions of the bottom surface of the first magnet, the first wall portion on a surface facing a second wall portion, and a pedestal are adhered together by using an UV adhesive. Similarly, a second magnet is placed on protrusions provided to the second wall portion of the base. Both end portions of the bottom surface of the second magnet, the second wall portion on a surface facing the first wall portion, and a pedestal are adhered together by using an UV adhesive.

This application is based on Japanese Patent Application No. 2006-002118 filed on Jan. 10, 2006, the contents of which are hereby incorporated by reference.

### BACKGROUND OF THE INVENTION

1. Field of the Invention

The present invention relates to a structure of an optical pickup provided to a disc device.

2. Description of Related Art

A disc device for recording and reproducing information on a disc has an optical pickup that projects a laser beam onto the disc. FIG. 2 shows an exploded perspective view of an actuator portion of a conventional optical pickup, and FIG. 3 shows a finished perspective view of the actuator portion of the conventional optical pickup.

The actuator portion 1 includes a base 2, a flexible printed circuit board (FPC) 3, a gel box 4, focusing wires 5, tracking wires 6, tilt servo wires 7, printed circuit boards (PCBs) 8, magnets 9, a screw 10, a focus coil 11, tracking coils 12, tilting coils 13, a lens holder 14, an objective lens 15, and a cover 16.

The focus coil 11 is adhered to the lens holder 14 so as to surround a lens attachment portion 14a of the lens holder 14. Each two of the four tracking coils 12 are adhered to the front and the rear side faces of the lens holder 14. The two tilting coils 13 are adhered to the bottom of the lens holder 14. Each of the two PCBs 8 is adhered to the right and the left side faces of the lens holder 14. Each end of the conductive wire drawn out from the focus coil 11 is soldered to a bare portion of copper foil on the PCB 8. In addition, the four tracking coils 12 are made up of a single conductive wire that is wound at four positions, and each end of the conductive wire is soldered to a bare portion of copper foil on the PCB 8. In addition, the two tilting coils 13 are made up of a single conductive wire that is wound at two positions, and each end of the conductive wire is soldered to a bare portion of copper foil on the PCB 8. Furthermore, the objective lens 15 is adhered to the lens attachment portion 14a.

In addition, a main portion 3a of the FPC 3 is adhered to the rear side 4a of the gel box 4, and side portions 3b formed on the right and the left sides of the main portion 3a are bent and adhered to the right and the left sides 4b of the gel box 4, respectively. Then, the screw 10 that penetrates the gel box 4 in the vertical direction at a hole portion 4c is screwed into a thread hole 2b provided to a pedestal 2a of the base 2 at the rear portion. Thus, the gel box 4 is fixed to the base 2.

Furthermore, the base 2 has a pair of wall portions 2c and 2d that protrude upward from the pedestal 2a so as to face each other and are formed by bending the front and the rear parts of the pedestal 2a. The base 2 has also a pair of wall portions 2f and 2g being bent and protruding upward from the pedestal 2a so as to face each other between the wall portion 2c and the wall portion 2d so as to be perpendicular to them. FIG. 4 shows a top view of the base 2 to which the magnets 9 are adhered, and FIG. 5A shows a cross section cut along the A-A line in FIG. 4. In addition, an elevation view in the direction of the arrow B in FIG. 4 is shown in FIG. 5B.

Two protrusions 2e are formed at the lower end of the wall portion 2c on the surface facing the wall portion 2d so as to contact the pedestal 2a. Then, the magnet 9 is placed on the protrusions 2e and is adhered to the wall portion 2c on the surface facing the wall portion 2d at two upper portions (adhesive positions BP1 shown in FIGS. 5A and 5B) by using an adhesive. An anaerobic adhesive is used as the adhesive. The anaerobic adhesive is cured when air is cut off. Similarly, two protrusions 2e are formed at the lower end of the wall portion 2d on the surface facing the wall portion 2c so as to contact the pedestal 2a. Then, the magnet 9 is placed on the protrusions 2e and is adhered to the wall portion 2d on the surface facing the wall portion 2c at two upper portions (adhesive positions BP2 shown in FIG. 5B) by using an anaerobic adhesive.

In addition, the front right and the front left sides of the gel box 4 are provided with protruding wall portions 4d and 4e, and two rectangular parallelepiped protrusions 4f are formed between them. Then, the focusing wires 5 are arranged to pass through between the wall portion 4d and the protrusion 4f, and one end thereof is soldered to a bare portion of copper foil on the FPC 3 at the side portion 3b. The tracking wires 6 are arranged to pass through between the protrusions 4f, and one end thereof is soldered to a bare portion of copper foil on the FPC 3 at the side portion 3b. The tilt servo wires 7 are arranged to pass through between the protrusion 4f and the wall portion 4e, and one end thereof is soldered to a bare portion of copper foil on the FPC 3 at the side portion 3b. Then, a gel material is filled between the wall portion 4d and the protrusion 4f, between the protrusion 4f and the protrusion 4f, and between the protrusion 4f and the wall portion 4e.

Then, the lens holder 14 is arranged so that the wall portions 2f and 2g of the base 2 respectively pass through between the lens attachment portion 14a and the left wall portion of the lens holder 14, and between the lens attachment portion 14a and the right wall portion of the lens holder 14. One ends of the focusing wires 5, the tracking wires 6, and the tilt servo wires 7 are soldered to bare portions of copper foils on the PCBs 8 that are adhered to the right and the left sides of the lens holder 14. Thus, the lens holder 14 is retained by the wires in the space between the magnets 9. Then, the cover 16 is fitted to the wall portions 2c and 2d of the base 2 in such a way as to cover the lens holder 14 to complete the actuator portion 1.

Then, the focus coil 11 is supplied with current from the FPC 3 via the focusing wires 5 and the PCBs 8. Thus, the lens holder 14 is moved vertically between the magnets 9 so that a focus servo control is performed, which is a control for adjusting the laser beam projected from the objective lens 15 to the disc to be focused on the disc recording surface. Moreover, the tracking coils 12 are supplied with current from the FPC 3 via the tracking wires 6 and the PCBs 8. Thus, the lens holder 14 is moved in the right and left direction between the magnets 9 so that a tracking servo control is performed, which is a control for forcing the laser beam projected from the objective lens 15 to the disc to follow a track on the disc. Moreover, the tilting coils 13 are supplied with current from the FPC 3 via the tilt servo wires 7 and the PCBs 8. Thus, the lens holder 14 is turned in the roll direction between the magnets 9 so that a tilt servo control is performed, which is a control for making the laser beam projected from the objective lens 15 to the disc to be perpendicular to the disc recording surface.

Note that a structure related to the present invention is disclosed in JP-A-2003-272195, which is an actuator portion of an optical pickup having a lens holder and magnets fixed to an M type yoke by adhesive so that the lens holder and the yoke slide along a shaft fixed to a base.

However, the conventional actuator portion of the optical pickup mentioned above has a following problem. As described above, the magnet 9 is placed on the protrusions 2e of the base 2 and is adhered to the wall portion 2c on the surface facing the wall portion 2d or to the wall portion 2d on the surface facing the wall portion 2c at the two upper portions. However, since the magnet 9 is only placed on the protrusions 2e, it has little rigidity against bending of the wall portions 2c and 2d in the front and the rear directions. Therefore, the movement or the rotation of the lens holder 14 may cause a resonance of the wall portions 2c and 2d with the magnets 9 easily. If the resonance occurs, it will adversely affect recording and reproduction of information on the disc.

In addition, a syringe which is an injector-like tool is used for applying the anaerobic adhesive for adhesion of the magnet 9 in the manufacturing line of the optical pickup. In the adhering step, the anaerobic adhesive filled in the syringe is extruded from a tip of a needle to the adhesive positions by a predetermined quantity. However, since the anaerobic adhesive has a low viscosity, it is apt to make a clot at the needle tip of the syringe. As a result, a waste of the adhesive may be generated by the clot when it is extruded to the adhesive positions for adhesion of the magnet 9. In addition, while the manufacturing line is stopped, the adhesive may be wasted when it drops from the needle tip of the syringe. Therefore, a cost of the adhesive to be used may be increased to be a factor of a high cost of the optical pickup.

### SUMMARY OF THE INVENTION

An object of the present invention is to provide an optical pickup that can improve recording and reproducing performances on a disc without increasing a cost.

An optical pickup according to one aspect of the present invention includes a pedestal, a first wall portion and a second wall portion both protruding from the pedestal and facing each other, at least one first protrusion provided to the first wall portion on a first surface that faces the second wall portion, at least one second protrusion provided to the second wall portion on a second surface that faces the first wall portion, a first magnet placed on the first protrusion in contact with the first surface, a second magnet placed on the second protrusion in contact with the second surface, and a lens holder for retaining an objective lens, the lens holder moving and/or rotating between the first and the second magnets. Here, the first magnet at least at one position on a bottom surface thereof, the first surface, and the pedestal are adhered together by using an adhesive, and the second magnet at least at one position on a bottom surface thereof, the second surface, and the pedestal are adhered together by using an adhesive.

According to this structure, rigidity against bending of the wall portion is improved. Therefore, resonance of the wall portions with the magnets is hardly generated when the lens holder is moved or rotated, so recording and reproducing performances on a disc are improved.

Preferably in the structure mentioned above, both end portions of the bottom surface of the first magnet, the first surface, and the pedestal are adhered together by using an adhesive, and both end portions of the bottom surface of the second magnet, the second surface, and the pedestal are adhered together by using an adhesive. Thus, it becomes easy to apply adhesive in the manufacturing line of the optical pickup.

In addition, it is preferable to use an UV adhesive for adhesion of the magnet. Since the UV adhesive has a high viscosity, waste of the adhesive can be reduced compared with the anaerobic adhesive. As a result, the cost of the adhesive as well as the cost of the optical pickup can be reduced. Therefore, according to the present invention, an optical pickup that improves recording and reproducing performances on a disc without increasing the cost can be provided.

### BRIEF DESCRIPTION OF THE DRAWINGS

FIG. 1A is a cross section cut along A-A line in FIG. 4 showing an actuator portion of an optical pickup according to the present invention.

FIG. 1B is an elevation view in the direction of the arrow B in FIG. 4 showing the actuator portion of the optical pickup according to the present invention.

FIG. 2 is an exploded perspective view of the actuator portion of the optical pickup according to the conventional example and the present invention.

FIG. 3 is a finished perspective view of the actuator portion of the optical pickup according to the conventional example and the present invention.

FIG. 4 is a top view of a base to which magnets are adhered of the actuator portion of the optical pickup according to the conventional example and the present invention.

FIG. 5A is a cross section cut along A-A line in FIG. 4 showing the actuator portion of the conventional optical pickup.

FIG. 5B is an elevation view in the direction of the arrow B in FIG. 4 of the actuator portion of the conventional optical pickup.

### DETAILED DESCRIPTION OF PREFERRED EMBODIMENTS

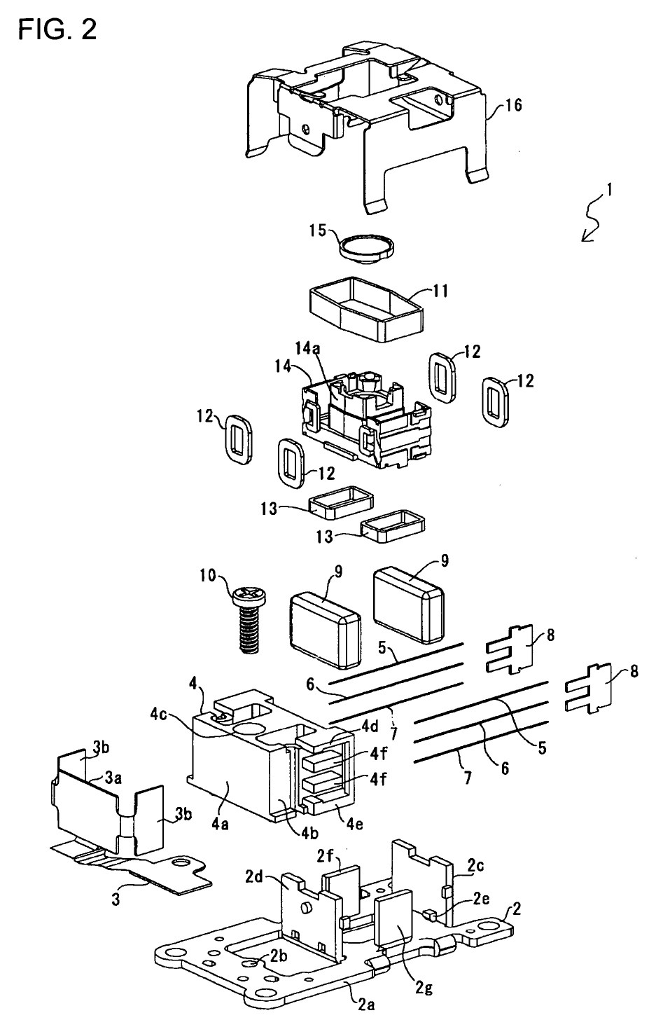

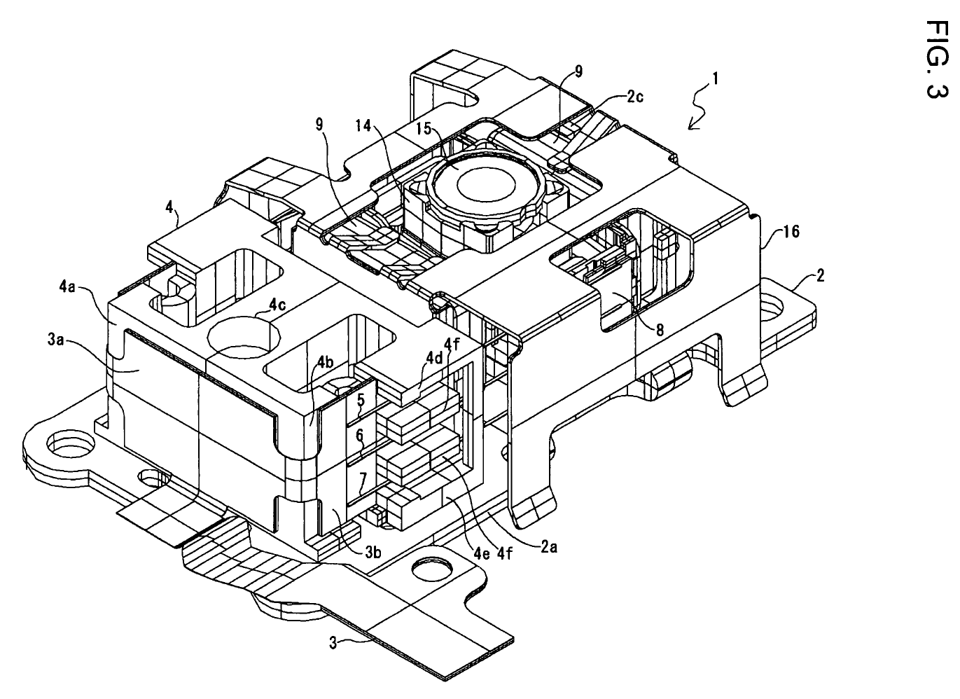

Now an embodiment of the present invention will be described with reference to the attached drawings. However, the components that are used for the actuator portion of the optical pickup according to the present invention are the same as those used for the conventional actuator portion of the optical pickup described above with reference to FIG. 2. Furthermore, assembling steps thereof are also the same as those of the conventional case except for the adhering step of the magnets 9. Therefore, detailed descriptions will be omitted except for the adhering step of the magnets 9, which constitutes technical features of the present invention.

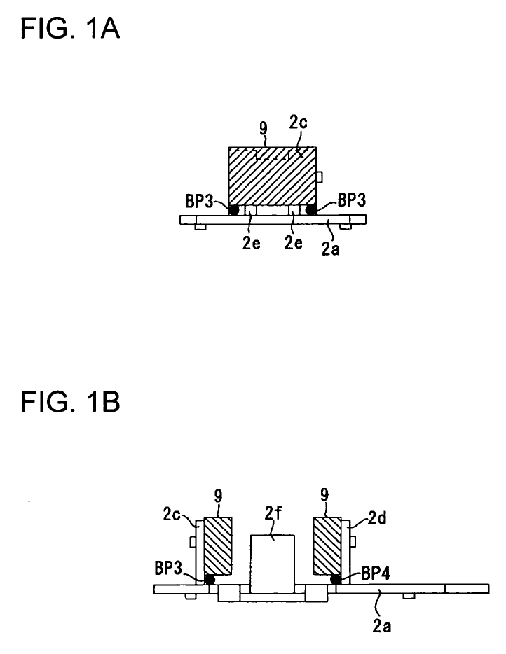

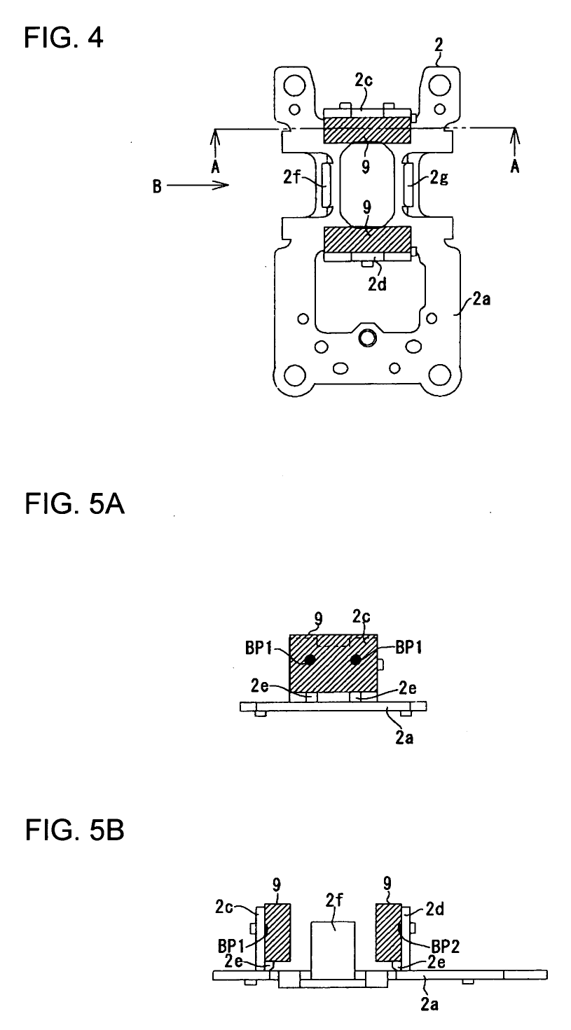

The actuator portion according to the present invention has a base 2. As shown in FIG. 2, a pedestal 2a of the base 2 includes a pair of wall portions 2c and 2d protruding upward from the pedestal 2a so as to face each other and formed by bending the front and the rear parts of the pedestal 2a. Also in the present invention, FIG. 4 shows a top view of the base 2 to which the magnets 9 are adhered. A cross section cut along A-A line in FIG. 4 is shown in FIG. 1A. In addition, an elevation view in the direction of the arrow B in FIG. 4 is shown in FIG. 1B.

Two protrusions 2e are formed at the lower end of the wall portion 2c on the surface facing the wall portion 2d (hereinafter referred to as a first surface) so as to contact the pedestal 2a. Then, the magnet 9 is placed on the protrusions 2e and sticks to the first surface of the wall portion 2c so as to adhere to and contact with the same by magnetic attraction. Then, both end portions of the bottom surface of the magnet 9, both end portions of the first surface of the wall portion 2c at the lowest part, and the pedestal 2a are adhered together by using an adhesive (see adhesive positions BP3 shown in FIGS. 1A and 1B). An UV adhesive that is cured when it is exposed to ultraviolet rays is used for the adhesive.

Similarly, Two protrusions 2e are formed at the lower end of the wall portion 2d on the surface facing the wall portion 2c (hereinafter referred to as a second surface) so as to contact the pedestal 2a. Then, the magnet 9 is placed on the protrusions 2e and sticks to the second surface of the wall portion 2d so as to adhere to and contact with the same by magnetic attraction. Then, both end portions of the bottom surface of the magnet 9, both end portions of the second surface of the wall portion 2d at the lowest part, and the pedestal 2a are adhered together by using the UV adhesive (see adhesive positions BP4 shown in FIG. 1B).

Thus, rigidity against bending of the wall portions 2c and 2d in the front and the rear directions is improved. Therefore, resonance of the wall portions 2c and 2d with the magnets 9 is hardly generated when the lens holder 14 retained by wires is moved or rotated between the magnets 9, so recording and reproducing performances on a disc are improved.

In addition, since the UV adhesive having a high viscosity is used for adhesion of the magnet 9, waste of the adhesive can be reduced compared with anaerobic adhesive. As a result, the cost of the adhesive as well as the optical pickup can be reduced.

Although the adhesive positions are both end portions of the bottom surface of the magnet 9 in the embodiment described above, the adhesive positions can be any other positions on the bottom surface of the magnet 9. In addition, it is sufficient to provide at least one adhesive position. For example, it is possible to provide only one adhesive position between the protrusions 2e on the bottom surface of the magnet 9. However, it is desirable to provide adhesive positions to both end portions on the bottom surface of the magnet 9 for easy application of the adhesive with the syringe in the assembling line of the optical pickup. In addition, it is sufficient if there is at least one protrusion 2e on each of the first and the second surfaces for supporting the magnet 9. For example, it is possible to provide one protrusion 2e at the middle portion in the right and the left direction on each of the first and the second surfaces.

In addition, the present invention can be applied to another type of optical pickup in which a lens holder slides along a shaft fixed to the base so as to move and rotate between the magnets.

What is claimed is:

1. An optical pickup, comprising:
a pedestal;
a first wall portion and a second wall portion both protruding from the pedestal and facing each other;
at least one first protrusion provided to the first wall portion on a first surface that faces the second wall portion;
at least one second protrusion provided to the second wall portion on a second surface that faces the first wall portion;
a first magnet placed on the first protrusion in contact with the first surface;
a second magnet placed on the second protrusion in contact with the second surface; and
a lens holder for retaining an objective lens, the lens holder moving and/or rotating between the first and the second magnets,
wherein the first magnet at least at one position on a bottom surface thereof, the first surface, and the pedestal are adhered together by using an adhesive, and the second magnet at least at one position on a bottom surface thereof, the second surface, and the pedestal are adhered together by using an adhesive.

2. The optical pickup according to claim 1,
wherein both end portions of the bottom surface of the first magnet, the first surface, and the pedestal are adhered together by using an adhesive, and both end portions of the bottom surface of the second magnet, the second surface, and the pedestal are adhered together by using an adhesive.

3. The optical pickup according to claim 1,
wherein the adhesive is an UV adhesive that is curable by irradiation with ultraviolet rays.

4. The optical pickup according to claim 2,
wherein the adhesive is an UV adhesive that is curable by irradiation with ultraviolet rays.

5. An optical pickup, comprising:
a pedestal;
a first wall portion and a second wall portion both protruding from the pedestal and facing each other;
at least one first protrusion provided to the first wall portion on a first surface that faces the second wall portion;
at least one second protrusion provided to the second wall portion on a second surface that faces the first wall portion;
a first magnet placed on the first protrusion in contact with the first surface;
a second magnet placed on the second protrusion in contact with the second surface; and
a lens holder for retaining an objective lens, the lens holder moving and/or rotating between the first and the second magnets,
wherein both end portions of the bottom surface of the first magnet, the first surface, and the pedestal are adhered together by using an UV adhesive, and both end portions of the bottom surface of the second magnet, the second surface, and the pedestal are adhered together by using an UV adhesive.
